(19) United States
(12) Patent Application Publication
(10) Pub. No.: US 2006/0072990 A1
(43) Pub. Date: Apr. 6, 2006

(54) Device for distributing unit load freight carriers

(76) Inventor: Heiko Suess, Frankfurt (DE)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/183,374

(22) Filed: Jul. 18, 2005

(30) Foreign Application Priority Data
Jul. 20, 2004 (DE) 10 2004 035 125.2

(51) Int. Cl. B65F 9/00

(52) U.S. Cl. 414/398

(57) ABSTRACT

A system for distributing unit load freight carriers, in particular pallets, which are transported on a main route or feeder route, among a plurality of secondary paths adjoining the main route or feeder route transversely, by means of a transfer element. In order to provide a device for distributing unit load freight carriers which has a significantly increased throughput capacity in comparison with the known solutions accompanied by a low level of structural complexity, it is proposed that the transfer element (11) is embodied as a wagon (8) which can be moved underneath the main route (2) or feeder route (2) and has arranged thereon a transfer element (11) which can be raised and lowered out of a transfer position which can be positioned underneath the transporting level of the main route (2) or feeder route (2) into a transfer position which is aligned with one of the secondary paths (7a to 7d) above the conveying level.

### BACKGROUND OF THE INVENTION

The present invention relates to a device for distributing unit load freight carriers and, in particular, to distributing pallets, which are transported on a main route or feeder route, among a plurality of secondary paths adjoining the main route or feeder route transversely, by means of a transfer element for picking up and lifting off in each case one freight carrier from the main route or feeder route and transferring it to a previously defined secondary path.

Devices of the described type are used, for example, in extraction areas of high-bay stores in order to transport freight carriers, generally pallets, to locations where, for example, rounds by trucks are made up or goods are buffered. The main route or feeder route via which the freight carriers are fed to the secondary paths are usually embodied as continuous conveyors which correspond to diverting-out elements which are used to transfer the freight carriers from the main route or feeder route to the secondary paths. In known devices of this type, the secondary paths are connected at a right angle to the main route or feeder route so-that the transfer element is also aligned at a right angle to the main route or feeder route in order to transfer the freight carriers of the secondary path.

It is known to provide elevating platforms, or cross conveyors, as transfer elements which are arranged so as to be capable of being raised and lowered between the conveyor elements of the main route or feeder route and, by engaging underneath the freight carriers, lift them off from the main route or feeder route and transfer them to the assigned secondary path. The transfer elements are arranged in a fixed fashion, i.e., each secondary path is assigned a transfer element whose lifting mechanism is activated as soon as a freight carrier is located above the transfer element.

It is also known to use transport wagons which collect the freight carriers from a transfer route and transport them to the destination, in this case each transport wagon is assigned a feeder route.

While the throughput capacity is restricted in the last-mentioned device by the time required to collect each pallet from the feeder location, the structural complexity in the first-mentioned solution is uneconomic because each secondary path has to be assigned a separate transfer element. When transport wagons are used, only individual transfer elements are assigned to a plurality of secondary paths, but the space required owing to the large number of conveyor elements needed to feed the freight carriers to each transport wagon is considerable.

### SUMMARY OF THE INVENTION

The present invention provides a system for distributing unit load freight carriers which has a throughput capacity that is significantly increased in comparison with the known solutions and is accompanied by low structural complexity.

According to an aspect of the invention, the transfer element is embodied as a wagon which can be moved underneath the main route or feeder route and has arranged thereon a transfer element which can be raised and lowered out of a transfer position which can be positioned underneath the transporting level of the main route or feeder route into a transfer position which is aligned with one of the secondary paths above the conveying level.

This aspect of the invention thus proposes a system in which the freight carriers are transported into the desired transfer position before one of the secondary paths on a continuous conveyor and are not transferred there by a fixed transfer element but rather by a wagon which can be moved underneath the main route or feeder route and which is equipped with the raisable and lowerable transfer element. This wagon is always moved to wherever a transfer takes place so that the same wagon can always serve a plurality of secondary paths for the purpose of extracting the freight carriers.

Because the main route and feeder route are embodied as continuous conveyors, the freight carriers can be transported directly from the store to the secondary path that is to be respectively assigned and where the transfer can take place immediately by means of the wagon which has been moved under it or is already waiting there.

The main route or feeder route may be embodied as a chain conveyor or belt conveyor. In such conveyors, the space between two chains or belts, which are arranged at a distance, is free for a transfer element which, according to the invention, is provided on the wagon which, for its part, can be moved underneath the conveyor in its direction of transport.

The wagon can preferably be moved on rails which are laid along the supporting frame of the main route or feeder route. The rails may be laid on the subgrade but also be attached directly to the supporting frame. Conventional drive devices, such as individual motors, chain drives, tooth drives, or the like, may be used as the drive.

According to one of the other aspects of the invention, the transfer element may be raised and lowered mechanically or under operation by a pressure medium. In the transport position of the wagon, the transfer element is lowered and can thus travel through under the pallets resting on the main route or feeder route.

According to another aspect of the invention, the transfer element of the device may be embodied as a cross conveyor. The cross conveyor itself may be embodied as a roller conveyor with roller axes aligned in the conveying direction of the main route or guide route, or as a chain conveyor by means of which a freight carrier can be transferred transversely with respect to the main route or feeder route to the conveyor which adjoins the transfer element on the secondary path. For this purpose, the roller conveyor can also be of driveable design or additional mechanical means or drives may be provided for transferring the freight carrier from the roller conveyor to the secondary path.

The secondary paths may be embodied as preparation paths or buffer paths. If, for example, rounds are to be made on the paths, all the freight carriers which are associated with a round are made available on the same secondary path.

If the cross conveyor and the secondary path are embodied, according to an aspect of the invention, as a gravity roller conveyor, the need for a separate drive for both can be avoided. In this case, the transfer element may also be embodied so as to be inclined in the direction of the secondary path in order to allow the freight carrier to roll downwards by means of gravity on the gravity roller conveyor after a retaining element has been released.

According to another aspect of the invention, a plurality of wagons may be controlled independently of one another to a main route or feeder route in order to increase the throughput capacity even further. By means of a corresponding, superordinate algorithm, the wagons may be controlled in such a way that, in each case, a wagon is moved to a transfer position or positioned where the charge carrier is to be transferred to the secondary path from the main route or feeder route.

The present invention may dispense with the multiple feeder routes which are necessary with known transport wagons. Since the wagons do not have to collect the freight carriers from a feeder location, the throughput capacity is significantly higher than with the known solutions. In comparison with continuous conveyor equipment with separate transfer elements at each diverting-out location, the present invention is distinguished by the elimination of conveyor means. The system is more cost-effective and requires less space so that in conjunction with the increased throughput capacity a considerable advantage is obtained in comparison with the known solutions.

These and other objects, advantages and features of this invention will become apparent upon review of the following specification in conjunction with the drawings.

### BRIEF DESCRIPTION OF THE DRAWINGS

FIG. 1 shows a plan view of a system, according to the invention, in a schematic illustration; and

FIG. 2 shows a cross section through the system according to FIG. 1.

### DESCRIPTION OF THE PREFERRED EMBODIMENT

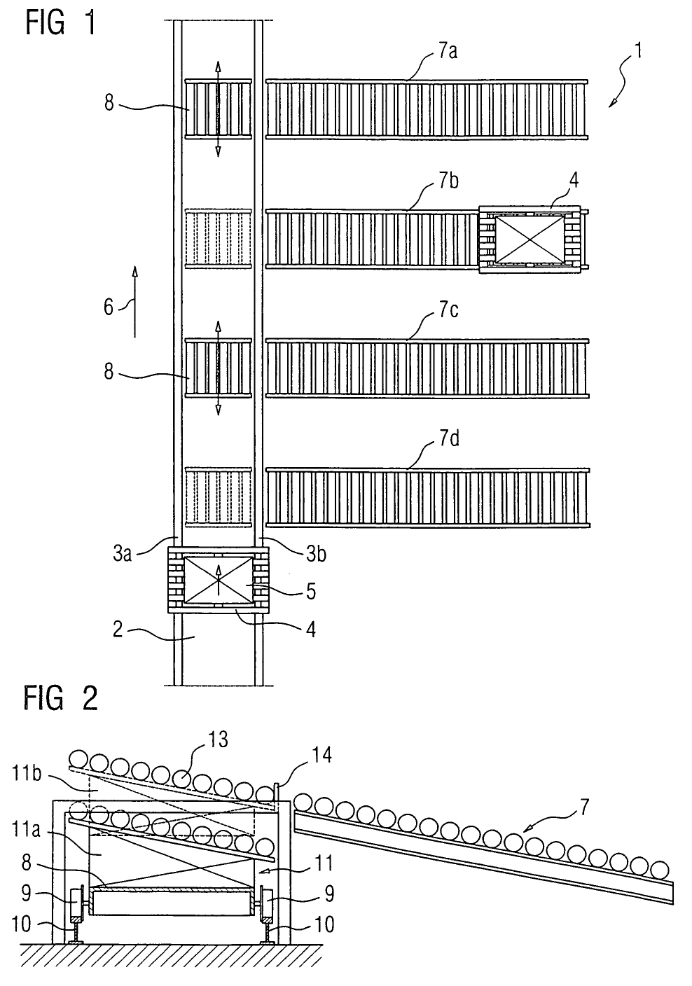

Referring now specifically to the drawings, and the illustrative embodiments depicted therein, FIG. 1 is a schematic illustration of a system, designated in its entirety by 1, for distributing unit loads which are transported on unit load freight carriers, such as pallets, or the like. The plan view in the drawing shows the main route 2 or feeder route 2 which is composed here of a chain conveyor with two conveyor chains 3a and 3b which are arranged at a distance from one another in parallel. The conveyor chains 3a, 3b support opposite sides of a pallet 4 on which a unit load component 5 is transported. The pallet 4 comes from the extraction zone of a store (not illustrated) and is conveyed in the direction 6 of transport via the main route 2 or feeder route 2. Secondary paths 7a to 7d branch off from the main route 2 or feeder route 2 at a right angle and serve to make available pallets 4, for example, at a truck 2 terminal. In order to transfer the pallets 4 from the main route 2 or feeder route to one of the secondary paths 7a to 7d, a transfer element is provided, which, in the illustrated embodiment, is embodied as a wagon 8. The wagon 8 is provided with four wheels 9 (FIG. 2) which roll on rails 10 which are laid in the longitudinal direction of the main route or feeder route. The wagon 8 is fitted with a transfer element 11 which can be raised and lowered with respect to the frame of the wagon 8. In the lowered position 11a, the transfer element with the rollers 12 of a cross conveyor arranged on it is located underneath the transporting level of the conveyor chains 3a, 3b of the main route 2 or feeder route 2 and is, therefore, able to move along the main route 2 or feeder route 2 under a pallet 4 resting on the main route 2 or feeder route 2. In the region of one of the secondary paths 7a to 7d, the pallet is stopped using known control means and the wagon 8 is moved under the pallet. The transfer element 11 is raised into a position in which it is aligned with the respective secondary path 7. If, as in the example illustrated in FIG. 2, the secondary path is embodied as a gravity roller conveyor and the cross conveyor which is arranged on the transfer element 11 is also embodied as a roller path 13 and is also arranged at an incline, the pallet can be transferred, after a stop 14 has been released, from the main route or feeder route to the secondary path and buffered at the end of said secondary path, for example, in order to make up a truck round.

As is illustrated in the top half of the drawing in FIG. 1, two wagons 8 can also move on a main route or feeder route and thus increase the capacity. Since the wagons 8 are each moved through under the pallets 4, which are transported on the main route 2 or feeder route 2, according to an appropriate logistic, a plurality of wagons can be used in order to serve two or more secondary paths simultaneously.

Changes and modifications in the specifically described embodiments can be carried out without departing from the principles of the invention which is intended to be limited only by the scope of the appended claims, as interpreted according to the principles of patent law including the doctrine of equivalents.

The embodiments of the invention in which an exclusive property or privilege is claimed are defined as follows:

1. A system for distributing unit load freight carriers, comprising:
a main route or feeder route for transporting carriers among a plurality of secondary paths transversely adjoining the main route or feeder route; and
a transfer element for picking up and lifting off one freight carrier from said main route or feeder route and transferring that carrier to a previously defined secondary path;
wherein said transfer element comprises a wagon which can be moved underneath said main route or feeder route and has arranged thereon a transfer element, wherein said transfer element is adapted to be raised and lowered out of a transfer position which can be positioned underneath a transporting level of said main route or feeder route into a transfer position, aligned in said transfer position with one of said secondary paths above the conveying level.

2. The system as claimed in claim 1, wherein said main route or feeder route comprises a continuous conveyor.

3. The system as claimed in claim 2, wherein said main route or feeder route comprises a chain conveyor or belt conveyor.

4. The system as claimed in claim 1, wherein said main route or feeder route comprises a chain conveyor or belt conveyor.

5. The system as claimed in claim 4, wherein said wagon is moveable on rails that are laid longitudinally in a supporting frame of said main route or feeder route.

6. The system as claimed in claim 3, wherein said wagon is moveable on rails that are laid longitudinally in a supporting frame of said main route or feeder route.

7. The system as claimed in claim 2, wherein said wagon is moveable on rails that are laid longitudinally in a supporting frame of said main route or feeder route.

8. The system as claimed in claim 1, wherein said wagon is moveable on rails that are laid longitudinally in a supporting frame of said main route or feeder route.

9. The system as claimed in claim 1, wherein said transfer element is adapted to be raised and lowered mechanically or under operation by a pressure medium.

10. The system as claimed in claim 9, wherein said transfer element comprises a cross conveyor.

11. The system as claimed in claim 10, wherein said cross conveyor comprises a roller conveyor.

12. The system as claimed in claim 11, wherein said roller conveyor is driven.

13. The system as claimed in claim 10, wherein said cross conveyor comprises a chain conveyor.

14. The system as claimed in claim 10, wherein said secondary paths are preparation paths or buffer paths.

15. The system as claimed in claim 2, wherein said secondary paths are preparation paths or buffer paths.

16. The system as claimed in claim 1, wherein said secondary paths are preparation paths or buffer paths.

17. The system as claimed in claim 14, wherein said cross conveyor and said secondary paths are embodied as gravity roller conveyors.

18. The system as claimed in claim 1, wherein said cross conveyor and said secondary paths are embodied as gravity roller conveyors.

19. The system as claimed in claim 17, including a plurality of wagons assigned to said main route or feeder route, said plurality of wagons generally controlled independently of one another.

20. The system as claimed in claim 1, including a plurality of wagons assigned to said main route or feeder route, said plurality of wagons generally controlled independently of one another.
